(19) United States
(12) Patent Application Publication
(10) Pub. No.: US 2014/0310972 A1
(43) Pub. Date: Oct. 23, 2014

(54) Centrifugal pellet dryer and dewatering assembly

(71) Applicants: George Holmes, West Chicago, IL (US); Tadausz Rybka, Streamwood, IL (US)

(72) Inventors: George Holmes, West Chicago, IL (US); Tadausz Rybka, Streamwood, IL (US)

(21) Appl. No.: 14/187,303

(22) Filed: Feb. 23, 2014

Related U.S. Application Data
(63) Continuation of application No. 12/679,255, filed on Mar. 19, 2010, now abandoned.
(60) Provisional application No. 60/973,635, filed on Sep. 19, 2007.

(51) Int. Cl. F26B 17/30

(52) U.S. Cl. CPC F26B 17/30
USPC 34/58

(57) ABSTRACT

A centrifugal pellet dryer having a perforated rotating basket disposed in a housing and configured to rotate. A pellet slurry conduit conveys pellet slurry to be dried. A water baffle is coupled to a seal assembly to form a water chamber. A variable speed AC motor causes the basket to rotate.

This is a continuation of application Ser. No. 12/679,255 filed Mar. 19, 2010 which was a National Phase entry of PCT/US08/76877 filed Sep. 18, 2008 which claimed priority from Provisional Application number 60/973,635 filed Sep. 19, 2007. Application Ser. No. 12/679,255, PCT/US08/76877 and 60/973,635 are hereby incorporated by reference in their entirities.

### FIELD OF THE INVENTION

This invention pertains to the field of pellet dryers that are used to dry plastic pellets after the pellets have been extruded through a pelletizer. More specifically, the invention pertains to separating and drying plastic pellets as they are carried in a fluid stream.

### BACKGROUND OF THE INVENTION

Extruders and processes for extruding plastic material and forming pellets therefrom have been known and used for some time. Once plastic pellets have been extruded, they are commonly placed into a fluid stream, such as water. The fluid stream serves to cool the plastic pellets and allow them to form, while also carrying the plastic pellets to subsequent steps in the process. Such an extruder or pelletizer may be referred to as an underwater pelletizer.

U.S. Pat. No. 4,529,370 illustrates one example of a conventional underwater pelletizer. Another example of a conventional underwater pelletizer is shown in U.S. Pat. No. 5,059,103.

One subsequent step in the pelletizing process is drying the plastic pellets. However, in order to dry the pellets, the pellets must be separated from the fluid stream. Conventional centrifugal pellet dryers can be seen in U.S. Pat. Nos. 4,565,015 and 5,611,150. Conventional centrifugal pellet dryers operate to separate the pellets from a slurry of pellets and water, but often cause deformation of the pellets or produce plastic remnants that may become imbedded in the parts of the pellet dryer machinery and often must be cleaned out to avoid contaminating subsequent batches of pellets.

### BRIEF SUMMARY OF THE INVENTION

An embodiment of a centrifugal pellet dryer includes a pellet stream inlet port, a rotating dewatering basket, a fluid exit port, and a pellet discharge port. In the illustrated embodiment, the rotating dewatering basket is a perforated material formed into a conical shape, so as to direct outwardly the pellets as the basket is rotating. The mesh material also allows for the rotational discharge of water as the pellets make their way toward the perimeter of the conical basket. The basket may be connected to a drive motor by a quick disconnect coupling that permits the basket to be quickly removed for cleaning or replacement. Air may be forced into the pellet dryer to provide additional drying capability.

The centrifugal pellet dryer may be assembled with a predewatering unit. The predewatering unit has a series of slurry water deflectors rotatably coupled to a support bracket and disposed within a screen sleeve. A pellet slurry is input to the predewatering unit and enters the screen sleeve. The slurry impacts the deflectors causing water to be deflected through the sleeve, where it flows to a water outlet, while the pellets sift through the screen sleeve and collect at a pellet discharge port. The pellets are discharged through the pellet discharge port to an inlet of the centrifugal pellet dryer. The predewatering unit may include a series of clean-out water pipes each having a series of sprayer heads for flushing the screen sleeve with high pressure water during a clean-out cycle.

### BRIEF DESCRIPTION OF THE DRAWINGS

An exemplary embodiment is described below with respect to the following drawings, wherein:

FIG. 1 is a cutaway side view of an embodiment of a centrifugal pellet dryer and predewatering unit assembly;

FIG. 2 is a cutaway side view of the centrifugal pellet dryer of FIG. 1;

FIG. 3 is a cutaway side view of the predewatering unit of FIG. 1; and

FIG. 4 is a top view of the predewatering unit of FIGS. 1 and 3.

### DETAILED DESCRIPTION OF THE INVENTION

The following description of certain exemplary embodiments further illustrate the invention but, of course, should not be construed as in any way limiting its scope.

Conventional pellet dryers operate to remove pellets from a fluid stream and dry the pellets, but often cause damage to the pellets when the pellets contact the drying machinery that produces remnants such as pellet dust, flakes, and “angel hair”. Furthermore, conventional dryers are often difficult to clean and prepare for subsequent drying batches or processes, wherein the remnants from previous processes may contaminate the pellets, such as pellets of one color being contaminated by remnants of a different color.

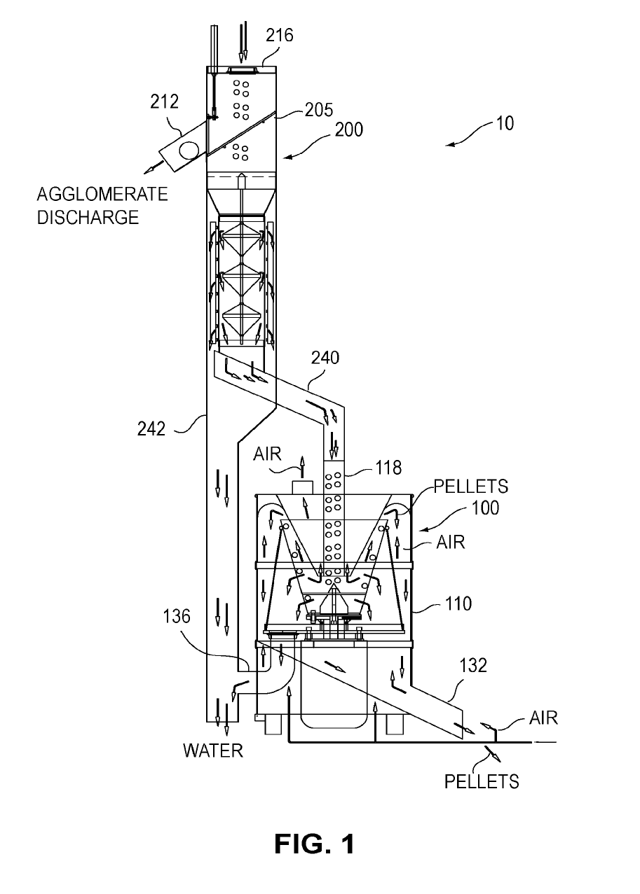

FIG. 1 is a side view of an embodiment of an assembly 10 having a centrifugal pellet dryer 100 and predewatering unit 200. A slurry of plastic pellets and water produced by an underwater pelletizer enters inlet 216 of predewatering unit 200. The predewatering unit 200 performs a partial separation of water from the pellets, with pellets being directed to pellet discharge port 240 and water being directed to water outlet 242 so that the water can be disposed of or recirculated to the underwater pelletizer that is producing the pellets.

The partially dewatered pellets from pellet discharge port 240 of predewatering unit 200 enter pellet slurry inlet 118 of centrifugal pellet dryer 100, where additional water is removed through centrifugal force and disposed or recirculated to the underwater pelletizer via water outlet return 136. The dried pellets are output via pellet discharge port 132. Air may be input to dryer 100 via pellet discharge port 132 to aid the drying process.

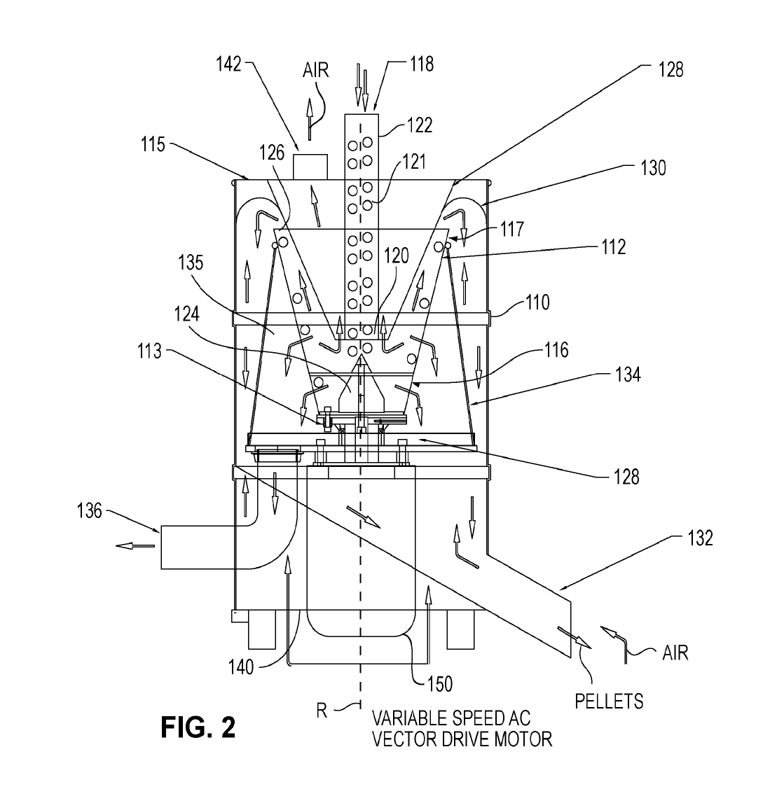

FIG. 2 is a cut-away side view of an embodiment of a centrifugal pellet dryer 100. In the embodiment shown, centrifugal pellet dryer 100 has a rotating basket 112 housed within a dryer housing 110. In the illustrative embodiment, rotating basket 112 is a cone or frusto-conical shape that is positioned such that a closed portion 116 of the cone-shaped rotating basket 112 is pointed downwardly. An open portion 117 of the basket 112 is wider than the closed portion 116 such that rotation of basket 112 about axis R causes pellets to migrate from the closed portion 116 towards the open portion 117 and out of basket 112 through opening 126 for collection within the dryer housing 110.

In operation, a pellet slurry 122 (i.e. the fluid carrying pellets) enters pellet slurry inlet 118 and passes through conduit 121 toward pellet slurry outlet port 120 such that the slurry is directed toward the closed portion 116 of basket 112. In the illustrated embodiment, conduit 121 is substantially aligned with rotational axis R within rotating basket 112, and pellets 122 are shown being carried by the fluid stream toward closed portion 116. A flow director 124 may be optionally coupled to rotating basket 112 near closed portion 116 to assist in the distribution of the pellet slurry 122. Flow director 124 illustratively rotates with rotating basket 112 and prompts the fluid/slurry flow to be directed outwardly from axis R toward the circumscribing housing 110 of centrifugal dryer 100.

Rotating basket 112 is formed of a mesh or other perforated material, such that the fluid can pass through the basket 112, but pellets 122 cannot. Rather, pellets 122 are redirected upwardly toward opening 126 of the open portion 117 by the centrifugal force of the rotation of basket 112. In the illustrated embodiment, an internal pellet deflector 128 extends inside the open portion 117 of basket 112 and combines with pellet discharge diverter 130 to direct pellets that exist basket 112 through opening 126 downwardly through dryer housing 110 toward pellet discharge port 132. While basket 112 is illustrated as being preferably conical in shape, other geometric configurations of basket 112 may employed provided that rotational motion of the basket 112 results in pellets 122 migrating due to centrifugal force toward open portion 117 for discharge through the opening 126 in the basket 112. For example, the basket 112 may be curved or stepped with the diameter of the open portion 117 being larger than the diameter of the closed portion 116.

While pellets 122 are directed through the path described above, the fluid or slurry that carried the pellets is separated and directed in the following manner. As the slurry flows toward closed portion 116, it is redirected by flow director 124 toward the perimeter (outer surface) of rotating basket 112. As noted above, basket 112 is perforated or formed of mesh or some other permeable material such that the fluid can permeate through the basket 112 while the pellets 122 cannot. Such permeation is assisted by the centrifugal force from rotating basket 112, as well as, in the example shown, the force of gravity that results from the intentional positioning of rotating basket 112 such that its opening 126 is at an upward point generally directed away from the vector of gravity.

In the embodiment shown, rotating basket 112 is driven to rotate by variable speed AC vector drive motor 150 within water chamber 135 formed by water baffle 134 and dual seal assembly 138. The bottom of the cone of rotating basket 112 is solid and, in this example, attaches to motor 150 via a quick disconnect drive coupling 113 that permits the conical rotating basket 112 to be quickly removed for cleaning or replacement. Seal 138 protects motor 150 from the water within chamber 135. As basket 112 rotates, pellets migrate due to centrifugal force toward the outermost diameter of the cone of basket 112, which is adjacent opening 126 and pellet discharge diverter 130.

After permeating through rotating basket 112, fluid is contained and shielded from drying pellets by water baffle 134, collected within water chamber 135, and then directed toward water outlet 136 so that the fluid can be disposed of or reused in subsequent slurry flows. Once again, in the embodiment shown, baffle 134 utilizes a conical shape to match the configuration of basket 112 and in order to assist with directing the fluid. A dual seal assembly 138 may also be utilized to further seal the fluid from components of the centrifugal pellet dryer 100, such as motor 150.

It is also contemplated that air may be directed through the housing 110 of centrifugal pellet dryer 100 so as to quicken the drying process for pellets 122. The air may be heated or cooled as required by the particular use. Air may be input via pellet discharge port 132. Alternatively, or in addition, air may be input to the housing of dryer 100 by air inlet 140 formed in the bottom portion of the housing 110 of centrifugal pellet dryer 100. The air speed may, for example, be controlled by varying the back pressure applied to air outlet 142 formed in the top cover 115 of the dryer 100.

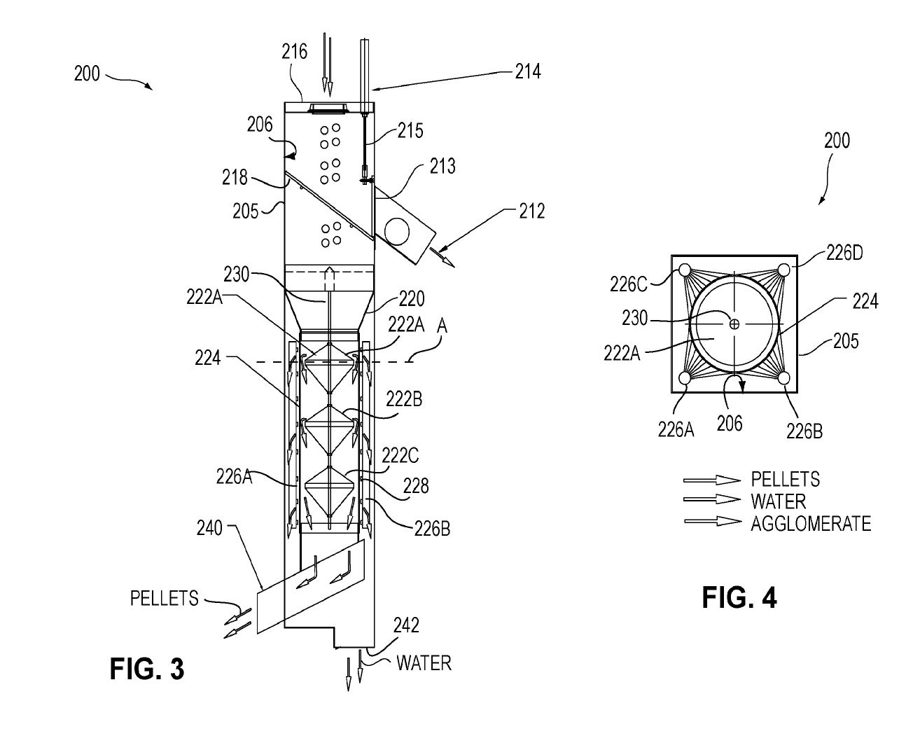

FIG. 3 is a cutaway side view of an exemplary embodiment of predewatering unit 200. Predewatering unit 200 is composed of a substantially hollow housing 205 having an inner surface 206. The housing 205, in this example, has a square cross-section, but may also be fabricated with other configurations. A pellet slurry from, for example, an underwater pelletizer is received at inlet 216 and may contain agglomerate.

An agglomerate discharge port 212 permits larger pieces of material, such as pieces of extruded plastic, to be removed from the inlet 216 to prevent the agglomerate from blocking predewatering unit 200. A coarse screen 218 is disposed inside housing 205 spanning the inner surface 206 so material from inlet 216 encounters coarse screen 218. Coarse screen 218 filters the pellet slurry allowing the pellets to pass through the screen, but trapping agglomerate and directing it toward agglomerate discharge port 212. In the embodiment shown, coarse screen 218 is disposed at an angle that directs material trapped by the screen towards the agglomerate discharge port 212. Agglomerate may be produced, for example, during a start-up procedure for an underwater pelletizer. In the exemplary embodiment shown, an air cylinder 214 is used to actuate discharge port flap 213 via actuating rod 215 in order to open flap 213 to open agglomerate discharge port 212 to pellet slurry inlet 216 and permit the discharge of agglomerate.

Once the pellet slurry has passed through coarse screen 218 it enters funnel 220, which spans the inner counter of housing 205 and directs the pellet slurry toward slurry water deflectors 222A-C suspended within dewatering screen 224 by support bracket 230. Slurry water deflectors 222A-C are connected to support bracket 230 by swivel connectors that allow the deflectors to swivel with respect to bracket 230 in response to a flow of pellet slurry impacting on the deflectors. Deflectors 222A-C, in this exemplary embodiment, have conical top and bottom surfaces and dewatering screen 224 has a complementary circular cross-section. However, other shapes for the deflectors 222A-C and dewatering screen 224 may also be effective. FIG. 4 is a cut-away top view along plane A shown in FIG. 3 that further illustrates the disposition of deflectors 222A-C with respect to screen 224. Note that the diameter or outer contour of deflectors 222A-C is smaller than and preferably complementary to the diameter or inner contour of dewatering screen 224 such that a space is provided between the deflectors 222A-C and screen 224 sufficient to permit pellets to pass between the outermost diameter or countour of the deflector and the screen 224.

In operation, when the pellet slurry is directed by funnel 220 toward deflectors 222A-C, the water within the slurry is deflected through screen 224 toward an inner surface 206 of housing 205 of predewatering unit 200. The water runs down the inner surface 206 under gravitational pull, in this example, and is collected at water outlet 242 for disposal or return to the underwater pelletizer or a reservoir tank. Pellets from the slurry are trapped within screen 224 and gravitate past deflectors 222A-C toward pellet discharge port 240, where they are discharged into the pellet slurry input 118 of centrifugal dryer 100. Deflectors 222A-C are movably or rotationally mounted to bracket 230 to permit the deflectors to move under the influence of the pellet flow. Note that in the embodiment shown, the deflectors 222A-C have a larger volume lower portion than the upper portion that is oriented toward funnel 220.

FIGS. 3 and 4 also illustrate a series of clean-out sprayer pipes 226A-D that may be used to flush out debris trapped in screen 224. Each spray pipe 226A-D is provided with a series of sprayer outlets 228 that direct a spray of water toward screen 224 during a clean-out process. The debris dislodged by the spray from the sprayer outlets is flushed out pellet discharge port 240. As a result, the predewatering unit may be rapidly cleaned between pellet drying cycles to remove debris, such as debris from differently colored pellets that may contaminate pellets in subsequent drying operations.

The various elements and combinations of the present predewatering unit allow for a single layer of permeable material to screen and dewater pellets. This single layer of material provides a single-step agglomerates-removal system. Such a system is simpler and increases efficiency in de-watering and agglomerates removal. Moreover, the centrifugal dewatering unit and process disclosed accelerates de-watered pellets centrifugally while the rotating basket design allows the pellets to rise vertically with low impact on the pellets, which allows water to be spun off of pellets while generating low deformation of pellets and debris. Optionally controlling internal airflow may increase drying capacity.

It is also advantageous that the present system creates a pellet flow that has little to no impact with machinery. Where other systems have created significant pellet impact with rotor blades, the present system does not utilize rotor blades to direct the flow of fluid or pellets. This greatly eliminates the dust, flakes, and angel hair that can be created by pellet impact found in other systems, which also leads to less maintenance and cleaning required.

Still another advantage is the short amount of time needed to change between uses, especially when changing between black and white pellet products. Where prior systems might have required laborious cleaning and purging of materials, the presently contemplated system incorporates a self-purging process that drastically reduces production downtime and labor hours. Moreover, material changes can be accomplished quickly with no risk of cross-contamination.

All references, including publications, patent applications, and patents, cited herein arc hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) arc to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

1. A centrifugal pellet dryer comprising:
a dryer housing having a top cover on an upper portion of the dryer housing and a pellet discharge port on a lower portion of the dryer housing;
a frustoconical shaped rotating basket disposed within the dryer housing, the rotating basket having an open portion that is substantially the widest part of the rotating basket and is disposed towards the upper portion of the dryer housing, where the open portion is substantially open to allow pellets to escape, the rotating basket having a closed portion disposed towards a lower portion of the basket and having a diameter less than a diameter of the open portion, and where the rotating basket has perforations formed therein that permit water to exit the rotating basket and trap pellets;
a pellet slurry conduit having a pellet slurry inlet port for receiving a pellet slurry and a pellet slurry outlet port, where the pellet slurry conduit is disposed to convey the pellet slurry received at pellet slurry inlet port through the top cover of the dryer housing to the pellet slurry outlet port;
a seal assembly mounted within the dryer housing having a water outlet opening and a motor shaft opening, where the seal assembly permits the passage of pellets between the dryer housing and the seal assembly;
a water baffle coupled to the seal assembly to form a water chamber that encloses the rotating basket except for the open portion;
a water outlet return coupled to the water outlet opening of the seal assembly and passing through the dryer housing to permit water to flow out of the water chamber formed by the water baffle and the seal assembly; and
a pellet deflector disposed within the dryer housing and in communication with the open portion of the rotating basket, the pellet deflector forming a pellet chamber within the dryer housing that is external to the water chamber formed by the water baffle and the seal assembly, where the pellet chamber is in communication with the pellet discharge port;
A variable speed AC vector drive motor mounted below said seal assembly with a shaft extending vertically and coupled to said rotating basket, said motor causing said rotating basket to rotate.
